(19) United States
(12) Patent Application Publication
(10) Pub. No.: US 2006/0076884 A1
(43) Pub. Date: Apr. 13, 2006

(54) Organic electroluminescent device for preventing overflow of a sealant

(75) Inventor: Jung Keun Ahn, Kyongsangbuk-do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/245,210

(22) Filed: Oct. 7, 2005

(30) Foreign Application Priority Data
Oct. 11, 2004 (KR) 2004-80823
Oct. 12, 2004 (KR) 2004-81462
Oct. 12, 2004 (KR) 2004-81464

(51) Int. Cl. H01J 1/62

(52) U.S. Cl. 313/504

(57) ABSTRACT

The present invention relates to an organic electroluminescent device for preventing overflow of a sealant. The organic electroluminescent device including a cell section which has a plurality of pixels formed on a substrate has at least one sealant overflow preventing section and a cell cap. The sealant overflow preventing section is formed on the substrate around the cell section. The cell cap has a shape corresponding to the sealant overflow preventing section, and is adhered to the substrate through a sealant. In the organic electroluminescent device of the present invention, a cell cap inserting section is inserted between sealant overflow preventing sections so that the length of a pathway through which a sealant moves is augmented. Hence, the sealant may not be overflowed into the internal space of the cell cap.

### CROSS-REFERENCE TO RELATED APPLICATIONS

This application claims priority from Korean Patent Application Nos. 2004-80823, filed on Oct. 11, 2004, and 2004-81462 and 2004-81464, filed on Oct. 12, 2004, the contents of which are incorporated herein by reference in their entirety.

### BACKGROUND OF THE INVENTION

1. Field of the Invention

The present invention relates to an organic electroluminescent device. More particularly, the present invention relates to an organic electroluminescent device for preventing overflow of a sealant.

2. Description of the Related Art

The present organic electroluminescent device as self light-emitting device emits a light having a predetermined wavelength when a certain voltage is applied thereto.

FIG. 1 is a plane view illustrating a conventional organic electroluminescent device.

In FIG. 1, the organic electroluminescent device includes a cell section 20, a cell cap 140, and a sealant overflow preventing sections 108A, 108B, and 108C.

The cell section 20 includes a plurality of pixels. Here, the pixels each have an Indium Tin Oxide Film (hereinafter, referred to as “ITO film”) 40, an insulating layer 60, a wall 80, an organic layer 100, and a metal line layer 120. In case where a positive voltage is applied to the ITO film 40, and a negative voltage is applied to the metal line layer 120, the pixel emits a light having a certain wavelength.

The insulating layer 60 and the wall 80 are formed in sequence on a first part of the ITO film 40.

The organic layer 100 and the metal line layer 120 are formed in sequence on a second part of the ITO film 40.

The cell cap 140 is adhered to a substrate 10 through a sealant 160 in a sealing process to prevent the cell section 20 from moisture, etc. Here, the sealant 160 is injected from the outside.

The sealant overflow preventing sections 180A, 180B and 180C are formed to both sides of the sealing section as shown in FIG. 1 so that the sealant 160 is not overflowed into the outside or internal space of the cell cap 140. Here, the sealing section means an area where the sealant 160 is injected. However, in this case, a part of the sealant 160 was overflowed into the internal space of the cell cap 140. As a result, the organic electroluminescent device including a defective pixel was produced.

Accordingly, an organic electroluminescent device for preventing overflow of the sealant 160 has been required.

### SUMMARY OF THE INVENTION

It is a feature of the present invention to provide an organic electroluminescent device capable of preventing overflow of a sealant.

An organic electroluminescent device according to one embodiment of the present invention including a cell section which has a plurality of pixels formed on a substrate includes at least one sealant overflow preventing section and a cell cap. The sealant overflow preventing section is formed on the substrate around the cell section. The cell cap has a shape corresponding to the sealant overflow preventing section, and is adhered to the substrate through a sealant.

As described above, in an organic electroluminescent device of the present invention, a cell cap inserting section is inserted between sealant overflow preventing sections, and so the length of a pathway through which a sealant moves is augmented. Hence, the sealant is not overflowed into the internal space of the cell cap.

Also, in an organic electroluminescent device of the present invention, a sealant overflow preventing section crosses over a cell cap crossing section, and so the length of a pathway through which a sealant moves is increased. Therefore, the sealant is not overflowed into the internal space of the cell cap.

Moreover, in an organic electroluminescent device of the present invention, a sealant overflow preventing section is received into a cell cap reception section, and so a sealant is not overflowed into the internal space of a cell cap.

Further, in an organic electroluminescent device of the present invention, a sealant overflow preventing section is adhered to a cell cap cohesion section, and so a sealant is not overflowed into the internal space of a cell cap.

### BRIEF DESCRIPTION OF THE DRAWINGS

The above and other features and advantages of the present invention will become readily apparent by reference to the following detailed description when considered in conjunction with the accompanying drawings wherein:

FIG. 1 is a plane view illustrating a conventional organic electroluminescent device;

FIG. 2 is a sectional view illustrating an organic electroluminescent device according to a first embodiment of the present invention;

FIG. 3 is a sectional view illustrating an organic electroluminescent device according to a second embodiment of the present invention;

FIG. 4 is a sectional view illustrating an organic electroluminescent device according to a third embodiment of the present invention;

FIG. 5 is a sectional view illustrating an organic electroluminescent device according to a fourth embodiment of the present invention;

FIG. 6 is a sectional view illustrating an organic electroluminescent device according to a fifth embodiment of the present invention; and

FIG. 7 is a sectional view illustrating an organic electroluminescent device according to a sixth embodiment of the present invention.

### DESCRIPTION OF EMBODIMENTS

Hereinafter, the preferred embodiments of the present invention will be explained in more detail with reference to the accompanying drawings.

In the following drawings, the same reference numbers will be used to refer to the same or functionally-same parts as those shown in the previous drawings.

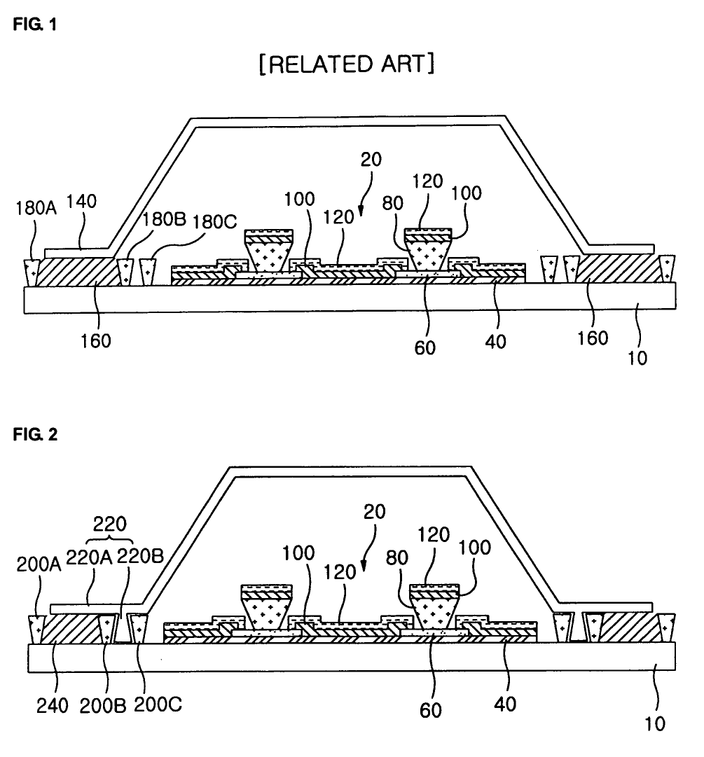

FIG. 2 is a sectional view illustrating an organic electroluminescent device according to a first embodiment of the present invention.

In FIG. 2, the organic electroluminescent device of the present invention includes a cell section 20, a plurality of sealant overflow preventing sections 200A, 200B and 200C, and a cell cap 220.

The cell section 20 includes a plurality of pixels. The pixels each has an Indium Tin Oxide Film (hereinafter, referred to as “ITO film”) 40, an insulating layer 60, a wall 80, an organic layer 100, and a metal line layer 120.

The organic layer 100 includes a hole transporting layer (HTL), an emitting layer (EML), and an electron transporting layer (ETL), deposited in sequence on the ITO film 40. In case that a positive voltage and a negative voltage are applied to the ITO film 40 and the metal line layer 120, respectively, the HTL transports holes provided from the ITO film 40 into the EML, and the ETL transports electrons provided from the metal line layer 120 into the EML. Subsequently, the holes and the electrons are recombined in the EML, and so a light having a certain wavelength is emitted from the EML.

The sealant overflow preventing sections 200A, 200B and 200C are located at both sides of a sealing section so that the sealant 240 may not be overflowed into the outside or internal space of the cell cap 220. Here, the sealing section means an area where the sealant 240 is injected. In particular, a first sealant overflow preventing section 200A of the sealant overflow preventing sections 200A, 200B and 200C prevents the sealant 240 from being overflowed into the outside of the cell cap 220. In addition, second and third sealant overflow preventing sections 200B and 200C prevent the sealant 240 from being overflowed into the internal space of the cell cap 220.

The cell cap 220 includes a cell cap sealing section 220A and a cell cap inserting section 220B. Here, the cell cap 220 according to one embodiment of the present invention is glass cap or metal cap.

The cell cap sealing section 220A seals the pixels, thereby preventing the pixels from moisture, etc.

The cell cap inserting section 220B is widened and extended from the cell cap sealing section 220A. In other words, the cell cap inserting section 220A has overhang shape. Also, the cell cap inserting section 220A is inserted between the second and third sealant overflow preventing sections 200B and 200C, and so a pathway through which the sealant 240 flows into the internal space of the cell cap 220 is increased than in the conventional device as shown in FIG. 2. Here, in case that the sealant 240 flows into the internal space of the cell cap 220, the sealant 240 flows along the pathway formed by combination of the second and third sealant overflow preventing sections 200B and 200C and the cell cap inserting section 220B. In this case, the flow of the sealant 240 is stopped in the pathway because the pathway is long, i.e. the sealant 240 may not overflow into the internal space of the cell cap 220.

In addition, to increase the length of the pathway, more sealant overflow preventing sections and cell cap inserting sections may be formed in the organic electroluminescent device. Hence, it will be immediately obvious to those skilled in the art that many modifications of the above sealant overflow preventing section and cell cap inserting section are possible.

The cell cap inserting section 220B according to one embodiment of the present invention is extended from the cell cap sealing section 220A by a sputtering process.

Hereinafter, a process of manufacturing the organic electroluminescent device of the present invention will be described in detail.

Firstly, the ITO film 40 is formed on a substrate 10.

Subsequently, the insulating layer 60 and the wall 80 are formed in sequence on the ITO film 40.

Then, the organic layer 100 and the metal line layer 120 are formed in sequence on the ITO film 40.

Subsequently, the sealant overflow preventing sections 200A, 200B and 200C are formed on the substrate 10. Here, the sealant overflow preventing sections 200A, 200B and 200C may be formed on the substrate 10 when the wall 80 is formed.

Then, the sealant 240 including spacers is injected into the sealing section.

Subsequently, the cell cap 220 is adhered to the substrate 10 by the injected sealant 240, and the cell cap inserting section 220B is inserted into the second and third sealant overflow preventing sections 200B and 200C. In this case, a constant distance is formed between the substrate 10 and the cell cap 220 by the spacers included in the sealant 240. Therefore, the pathway formed by combination of the second and third sealant overflow preventing sections 200B and 200C and the cell cap inserting section 220B has a constant height.

In short, the organic electroluminescent device of the present invention includes the cell cap inserting section 220B inserted between the second and third sealant overflow preventing sections 200B and 200C, and thus the pathway is longer than that of the conventional organic electroluminescent device. As a result, in the organic electroluminescent device of the present invention, the sealant 240 is not overflowed into the internal space of the cell cap 220, and so the pixels are protected from the sealant 240.

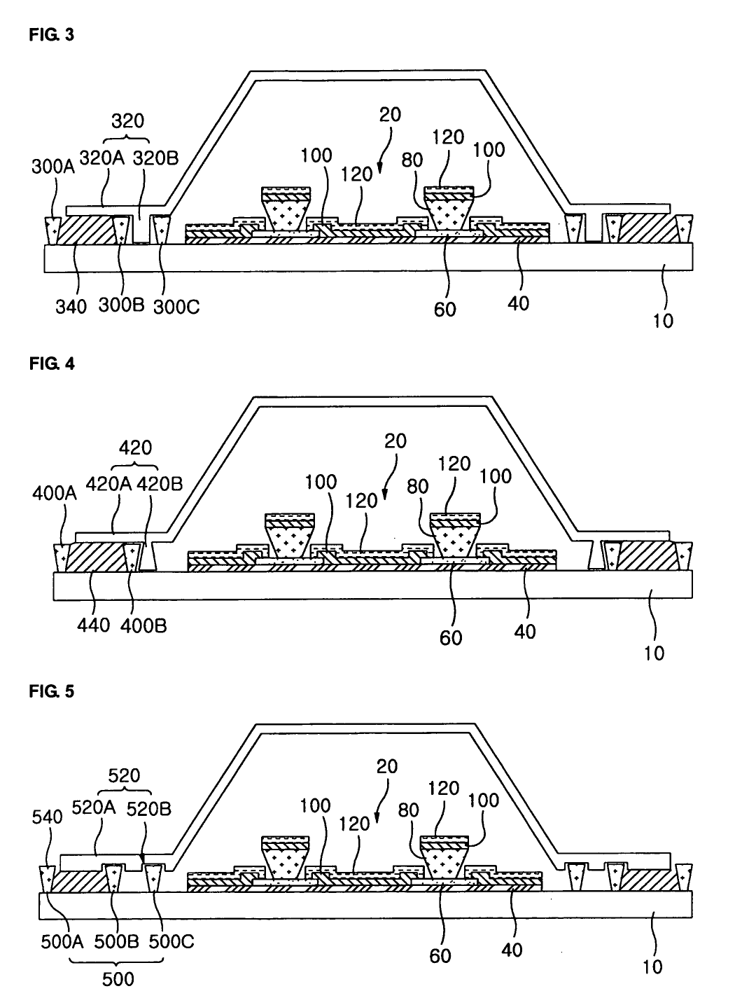

FIG. 3 is a sectional view illustrating an organic electroluminescent device according to a second embodiment of the present invention.

In FIG. 3, the organic electroluminescent device of the present invention includes a cell section 20, sealant overflow preventing sections 300A, 300B and 300C, and a cell cap 320.

The cell cap 320 includes a cell cap sealing section 320A and a cell cap inserting section 320B.

Since the elements of the second embodiment except the cell cap inserting section 320B are the same as in the first embodiment, further detailed descriptions concerning the same elements will be omitted.

The cell cap inserting section 320B has rectangular shape, and is inserted into the second and third sealant overflow preventing sections 300B and 300C. As a result, the pathway in the present invention is longer than that in the conventional device, and thus the sealant 340 is not overflowed into the internal space of the cell cap 320.

Now referring to FIG. 2 and FIG. 3, the cell cap inserting sections 220B and 320B have overhang shape or rectangular shape. In brief, the cell cap inserting sections may have any shape as long as they could be inserted into the sealant overflow preventing sections. Hence, it will be immediately obvious to those skilled in the art that many modifications of shape of the cell cap inserting section do not have any effect to the scope of the present invention.

FIG. 4 is a sectional view illustrating an organic electroluminescent device according to a third embodiment of the present invention.

In FIG. 4, the organic electroluminescent device of the present invention includes a cell section 20, sealant overflow preventing sections 400A and 400B, and a cell cap 420.

Since the elements of the third embodiment except the cell cap 420 are the same as in the first embodiment, further detailed descriptions concerning the same elements will be omitted.

The cell cap 420 includes a cell cap sealing section 420A and a cell cap crossing section 420B.

The cell cap sealing section 420A seals the pixels, thereby preventing the pixels from moisture, etc.

The cell cap crossing section 420B is widened and extended from the cell cap sealing section 420A. In addition, the cell cap crossing section 420B crosses over the second sealant overflow preventing section 400B in a sealing process as shown in FIG. 4. As a result, the pathway in the present invention is longer than that in the conventional device, and thus the sealant 440 is not overflowed into the internal space of the cell cap 420.

In an organic electroluminescent device according to another embodiment of the present invention, the second sealant overflow preventing section 400B and/or the cell cap crossing section 420B have rectangle shape or square shape, respectively.

In brief, the sealant overflow preventing section 400B and the cell cap crossing section 420B may have any shapes. Hence, it will be immediately obvious to those skilled in the art that many modifications of shape of the sealant overflow preventing section 400B and the cell cap crossing section 420B do not have any effect to the scope of the present invention.

FIG. 5 is a sectional view illustrating an organic electroluminescent device according to a fourth embodiment of the present invention.

In FIG. 5, the organic electroluminescent device of the present invention includes a cell section 20, sealant overflow preventing sections 500A, 500B and 500C, and a cell cap 520.

Since the cell section 20 is the same as in the first embodiment, further detailed descriptions concerning the cell section 20 will be omitted.

The sealant overflow preventing sections 500A, 500B and 500C are located around the cell section 20, particularly at both sides of the sealing section as shown in FIG. 5, thereby preventing overflow of a sealant 540. Here, the sealing section indicates an area where the sealant 540 is injected. In particular, a first sealant overflow preventing section 500A of the sealant overflow preventing sections 500A, 500B and 500C prevents the sealant 540 from being overflowed into the outside of the cell cap 520. In addition, second and third sealant overflow preventing sections 500B and 500C prevent the sealant 540 from being overflowed to the internal space of the cell cap 520.

The cell cap 520 includes a cell cap sealing section 520A and a cell cap reception section 520B as glass cap or metal cap.

The cell cap sealing section 520A seals the cell section 20, thereby preventing the pixels included in the cell section 20 from moisture, etc.

The cell cap reception section 520B has at least one groove for receiving the second and third sealant overflow preventing sections 500B and 500C as shown in FIG. 5. Hence, when the substrate 10 is adhered to the cell cap 520 by using the sealant 540, i.e. in a sealing process, the second and third sealant overflow preventing sections 500B and 500C are received into the cell cap reception section 520B. As a result, a pathway is formed between each of the sealant overflow preventing sections 500B and 500C and the cell cap reception section 520B. Here, the sealant overflow preventing sections 500B and 500C are closely received into the cell cap reception section 520B, and the pathway is considerably long. Accordingly, the sealant 540 may not be overflowed to the internal space of the cell cap 520.

In one embodiment of the present invention, the cell cap reception section 520B receives only the upper side of the second and third sealant overflow preventing sections 500B and 500C.

In another embodiment of the present invention, the cell cap reception section 520B may fully receive the second and third sealant overflow preventing sections 500B and 500C.

FIG. 5 shows two sealant overflow preventing sections 500B and 500C. However, the organic electroluminescent device of the present invention may include only a second sealant overflow preventing section, and thus a cell cap reception section includes one groove. In addition, FIG. 5 shows the sealant overflow preventing sections 500B and 500C having overhang shape. However, the sealant overflow preventing sections 500B and 500C may have various shapes such as rectangular shape, etc, and thus the cell cap reception section 520B has grooves corresponding to the sealant overflow preventing sections 500B and 500C. Hence, it will be immediately obvious to those skilled in the art that many modifications of the above sealant overflow preventing section and cell cap reception section are possible.

In short, in the organic electroluminescent device of the present invention, the sealant overflow preventing sections 500B and 500C are received into the cell cap reception section 520B, and so the pathway that the sealant 540 is moved is longer than that in the conventional organic electroluminescent device. Accordingly, in the organic electroluminescent device of the present invention, the sealant 540 is not overflowed into the internal space of the cell cap 520.

Hereinafter, a process of manufacturing the organic electroluminescent device of the present invention will be described in detail.

Firstly, an ITO film 40, an insulating layer 60, and a wall 80 are formed in sequence on a substrate 10.

Then, an organic layer 100 and a metal line layer 120 are formed in sequence on the ITO film 40.

Subsequently, sealant overflow preventing sections 500A, 500B and 500C are formed on the substrate 10. Here, the sealant overflow preventing sections 500A, 500B and 500C may be formed on the substrate 10 when the wall 80 is formed.

Then, the sealant 540 including spacers is injected into the sealing section.

Subsequently, the cell cap 520 is adhered to the substrate 10 by the injected sealant 540. In this case, the second and third sealant overflow preventing sections 500B and 500C are received into the cell cap reception section 520B, and thus a constant distance is formed between the substrate 10 and the cell cap 520 by the spacers included in the sealant 540. As a result, the pathway formed by combination of the second and third sealant overflow preventing sections 500B and 500C and the cell cap reception section 520B has a constant height. Here, in case that the cell cap 520 is glass cap, the cell cap reception section 520B is formed by an etching process.

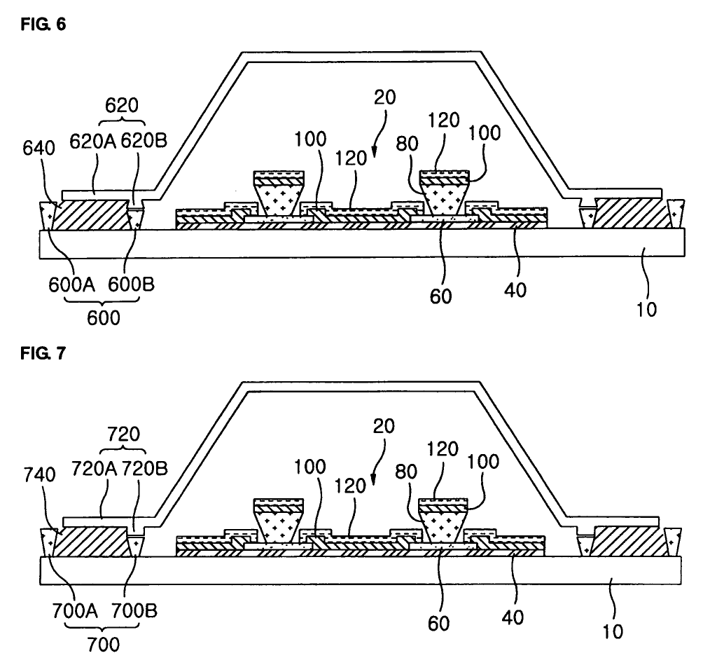

FIG. 6 is a sectional view illustrating an organic electroluminescent device according to a fifth embodiment of the present invention.

In FIG. 6, the organic electroluminescent device of the present invention includes a cell section 20, sealant overflow preventing sections 600A and 600B, and a cell cap 620.

Since the cell section 20 is the same as in the first embodiment of the present invention, further detailed descriptions concerning the cell section 20 will be omitted.

The sealant overflow preventing sections 600A and 600B are located around the cell section 20, particularly at both sides of the sealing section as shown in FIG. 6, thereby preventing overflow of a sealant 640. In particular, a first sealant overflow preventing section 600A of the sealant overflow preventing sections 600A and 600B prevents the sealant 640 from being overflowed into the outside of the cell cap 620. Additionally, a second sealant overflow preventing section 600B prevents the sealant 640 from being overflowed into the internal space of the cell cap 620.

The cell cap 620 includes a cell cap sealing section 620A and a cell cap cohesion section 620B.

The cell cap sealing section 620A seals the cell section 20 to prevent pixels included in the cell section 20 from moisture, etc.

The cell cap cohesion section 620B is extended from the cell cap sealing section 620A as shown in FIG. 6 to be adhered to the second sealant overflow preventing section 600B. As a result, a sealant 640 is not overflowed into the internal space of the cell cap 620 so that the pixels included in the cell section 20 are prevented from the sealant 640.

Also, it is desirable that the width of end of the cell cap cohesion section 620B is identical to that of end of the second sealant overflow preventing section 600B. Here, the cell cap cohesion section 620B is widened and extended from the cell cap sealing section 620A.

In another embodiment, the width of end of the cell cap cohesion section 620B may be different from that of end of the second sealant overflow preventing section 600B. In this case, the cell cap cohesion section 620B is adhered to the second sealant overflow preventing section 600B so that the sealant 640 may not be overflowed into the internal space of the cell cap 620.

In brief, in the organic electroluminescent device of the present invention, the cell cap cohesion section 620B is adhered to the second sealant overflow preventing section 600B so that the sealant 640 is not overflowed into the internal space of the cell cap 620, not like the conventional organic electroluminescent device.

Hereinafter, a process of manufacturing the organic electroluminescent device of the present invention will be described in detail.

Firstly, an ITO film 40, an insulating layer 60 and a wall 80 are formed in sequence on a substrate 10.

Then, an organic layer 100 and a metal line layer 120 are formed in sequence on the ITO film 40.

Subsequently, sealant overflow preventing sections 600A and 600B are formed on the substrate 10. In another embodiment, the sealant overflow preventing sections 600A and 600B may be formed on the substrate 10 when the wall 80 is formed.

Then, a sealant 640 is injected into a sealing section.

Subsequently, the cell cap 620 is adhered to the substrate 10 by the injected sealant 640. In this case, the cell cap cohesion section 620B is adhered to the second sealant overflow preventing section 600B, and so a constant distance is formed between the substrate 10 and the cell cap 620. Here, in case that the cell cap 620 is glass cap, the cell cap cohesion section 620B is formed from the cell cap sealing section 620A by a sputtering process.

FIG. 7 is a sectional view illustrating an organic electroluminescent device according to a sixth embodiment of the present invention.

In FIG. 7, the organic electroluminescent device of the present invention includes a cell section 20, sealant overflow preventing sections 700A and 700B, and a cell cap 720.

Since the other elements except the cell cap 720 are the same as in the fifth embodiment, further detailed descriptions concerning the same elements will be omitted.

The cell cap 720 includes a cell cap sealing section 720A and a cell cap cohesion section 720B.

The cell cap cohesion section 720B is extended from the cell cap sealing section 720A as shown in FIG. 7 to be adhered to the sealant overflow preventing section 700B, and has rectangular shape.

Now referring to FIG. 6 and FIG. 7, in the organic electroluminescent device of the present invention, the cell cap cohesion sections 620B and 720B each has overhang shape, rectangular shape and so on. Hence, it will be immediately obvious to those skilled in the art that many modifications of the above cell cap cohesion sections 620B and 720B are possible.

From the preferred embodiments for the present invention, it is noted that modifications and variations can be made by a person skilled in the art in light of the above teachings. Therefore, it should be understood that changes may be made for a particular embodiment of the present invention within the scope and the spirit of the present invention outlined by the appended claims.

What is claimed is:

1. An organic electroluminescent device including a cell section which has a plurality of pixels formed on a substrate comprising:
at least one sealant overflow preventing section formed on the substrate around the cell section; and
a cell cap having a shape corresponding to the sealant overflow preventing section, and adhered to the substrate through a sealant.

2. The organic electroluminescent device of claim 1, wherein the cell cap includes:
a cell cap sealing section adhered to the substrate through the sealant; and
a cell cap inserting section extended from the cell cap sealing section to be inserted between the sealant overflow preventing sections.

3. The organic electroluminescent device of claim 2, wherein the cell cap inserting section is widened and increased from the cell cap sealing section.

4. The organic electroluminescent device of claim 2, wherein the cell cap inserting section has rectangular shape.

5. The organic electroluminescent device of claim 2, wherein the cell cap inserting section is extended from the cell cap sealing section through a sputtering process.

6. The organic electroluminescent device of claim 1, wherein the cell cap is glass cap.

7. The organic electroluminescent device of claim 1, wherein the cell cap includes:
a cell cap sealing section adhered to the substrate through the sealant; and
a cell cap crossing section extended from the cell cap sealing section to cross over the sealant overflow preventing section.

8. The organic electroluminescent device of claim 7, wherein the cell cap crossing section is widened and increased from the cell cap sealing section.

9. The organic electroluminescent device of claim 7, wherein the cell cap crossing section has rectangular shape.

10. The organic electroluminescent device of claim 1, wherein the cell cap includes a cell cap sealing section in which a cell cap reception section for receiving the sealant overflow preventing section is formed.

11. The organic electroluminescent device of claim 10, wherein the cell cap reception section is groove for receiving the sealant overflow preventing section.

12. The organic electroluminescent device of claim 10, wherein the cell cap reception section is formed by an etching process.

13. The organic electroluminescent device of claim 1, wherein the cell cap includes:
a cell cap sealing section adhered to the substrate through the sealant; and
a cell cap cohesion section extended from the cell cap sealing section to be adhered to the sealant overflow preventing section.

14. The organic electroluminescent device of claim 13, wherein the width of end of the cell cap cohesion section is identical to that of end of the sealant overflow preventing section.

15. The organic electroluminescent device of claim 13, wherein the cell cap cohesion section is widened and increased.

16. The organic electroluminescent device of claim 13, wherein the cell cap cohesion section has rectangular shape.

17. The organic electroluminescent device of claim 13, wherein the cell cap cohesion section is extended from the cell cap sealing section by a sputtering process.
